(19) United States
(12) Patent Application Publication
(10) Pub. No.: US 2014/0112849 A1
(43) Pub. Date: Apr. 24, 2014

(54) METHOD FOR THE DEPOSITON OF METALS ON SUPPORT OXIDES

(71) Applicants: Fei Wen, Kahl am Main (DE); Barry W.L. Southward, Tulsa, OK (US); Liesbet Jongen, Waechtersbach (DE); Alexander Hoffmann, Hanau (DE); Juergen Gieshoff, Gelnhausen (DE)

(72) Inventors: Fei Wen, Kahl am Main (DE); Barry W.L. Southward, Tulsa, OK (US); Liesbet Jongen, Waechtersbach (DE); Alexander Hoffmann, Hanau (DE); Juergen Gieshoff, Gelnhausen (DE)

(73) Assignee: Umicore AG & Co., KG, Hanau-Wolfgang (DE)

(21) Appl. No.: 14/128,408

(22) PCT Filed: Jun. 14, 2012
(86) PCT No.: PCT/EP2012/061382

§ 371 Date: Jan. 7, 2014

(30) Foreign Application Priority Data
Jun. 21, 2011 (EP) 11170806.1

(51) Int. Cl. B01D 53/86; B01J 23/44; B01J 23/63; B01J 23/83; B01J 23/89; B01J 23/50; B01J 23/72; B01J 23/42; B01J 23/46

(52) U.S. Cl. CPC B01D 53/86; B01J 23/42; B01J 23/44; B01J 23/63; B01J 23/464; B01J 23/8906; B01J 23/50; B01J 23/72; B01J 23/462; B01J 23/83
USPC 423/210; 502/334; 502/333; 502/304; 502/332; 502/327; 502/348; 502/346; 502/303

(57) ABSTRACT

The present invention is directed to a process for the production of supported transition metals with high dispersion. The latter are deposited onto refractory oxides without using a further liquid solvent. Hence, according to this dry procedure no solvent is involved which obviates certain drawbacks connected with wet ion exchange, impregnation or other metal addition processes known in the art.

The present invention is directed to a process for the production of highly dispersed, oxide supported transition metal (TM) catalysts. The TM elements are deposited onto refractory oxides without the use of a conventional liquid solvent or aqueous intermediate. Hence, according to this dry procedure no solvent is involved which obviates certain drawbacks connected with wet ion exchange, impregnation or other metal addition processes known in the art.

Highly dispersed metal catalysts are desirable in many valuable applications, e.g. hydrogenation of polycondensed aromatics (U.S. Pat. No. 4,513,098), hydrogenation of benzaldehyde (U.S. Pat. No. 6,806,224), hydrogenation of carbon monoxide (U.S. Pat. No. 5,928,983), hydrocarbon synthesis (U.S. Pat. No. 6,090,742), CO oxidation (U.S. Pat. No. 7,381,682), partial oxidation of methane to CO and H₂ (US 2002/0115730), methanol oxidation in direct methanol fuel cells (US 2006/0159980), NOₓ purification in automotive exhaust treatment devices (U.S. Pat. No. 6,066,587), and so on. Typically for automotive exhaust treatment, diesel oxidation catalysts (DOC), diesel particulate filters (DPF), three-way catalysts (TWC), lean-NOx traps (LNT) and selective catalytic reduction (SCR) comprise one or more highly dispersed TM species from which the catalytic activity is derived. In most cases they are supported on a high surface refractory oxide that is stable at high temperatures to provide enhanced resistance of the TM particles against sintering and migration. Hence, the synthesis of refractory oxide supported TM catalysts is a topic of critical importance for catalytic applications.

A key characteristic for the production of effective catalysts is the ability to obtain a high dispersion of the metals on support oxides in order to obtain maximum catalytic function at the minimal concentration of applied transition metals. Conventionally, attempts to obtain high dispersions involve impregnation, precipitation or ion exchange of the transition metal salt on to the desired support oxide (Handbook of heterogeneous catalysis, 2^{nd} Ed, Vol 1, p 428; US20070092768, US2003236164, US2003177763, U.S. Pat. No. 6,685,899, U.S. Pat. No. 6,107,240, U.S. Pat. No. 5,993,762, U.S. Pat. No. 5,766,562, U.S. Pat. No. 5,597,772, U.S. Pat. No. 5,073,532, U.S. Pat. No. 4,708,946, U.S. Pat. No. 4,666,882, U.S. Pat. No. 4,370,260, U.S. Pat. No. 4,294,726, U.S. Pat. No. 4,152,301, DE3711280, WO2004043890, U.S. Pat. No. 4,370,260).

However, these conventional processes present significant limitations to achieving high dispersion and can instead result in a broad range of transition metal particle sizes due to a combination of factors e.g. generation and migration of soluble species resulting in heterogeneous transition metal distribution/TM gradients, uncontrolled agglomeration due to preferential adsorption effects or the formation of large metal particles arising from gross TM precipitation as a result of forced pH changes.

Moreover the current processes exhibit issues with respect to the integrity and functionality of the support oxide. The support is not chemically inert during injection and the TM adsorption step, which requires the intimate mixing of metal salt and support oxide can result in chemical attack and modification of the support oxide. For example, the acid extraction of the structure stabilising La³⁺ ions employed in conventional La₂O₃-doped Alumina or CeZrLa-based oxygen storage component will result from exposure to such support oxides to strongly acidic TM precursor salts. This extraction then can directly affect the slurry pH and temperature resulting in yet further complexity and process variability rendering the metal introduction process yet more difficult to control.

In addition, the metal nitrates or amine complexes typically employed in the current processes produce significant concentrations of toxic and environmentally damaging Nitrogen Oxides (NOₓ) during the subsequent calcination step required to permanently ‘fix’ the TM to the support.

U.S. Pat. No. 5,332,838 describe a catalyst comprising at least one member selected from the group consisting of copper aluminium borate and zero valent copper on a support comprising aluminium borate. In order to obtain the active catalyst a reducing step is necessary in order to generate the active copper in the zero valent state.

Alternatively, the literature describes two other well-known processes to provide high TM dispersion on support oxides, specifically vapour-based methods (Preparation of Solid Catalysts, 1999, Wiley-VCH, p 427, U.S. Pat. No. 4,361,479) and colloid-based methods (Dekker Encyclopaedia of Nanoscience and Nanotechnology, Marcel Dekker, p 2259; WO2011023897; EP0796147B1). However the former method, similar to the high temperature injection method, uses plasma or gas evaporation and again requires high-cost equipment, while the latter generally is a more complex synthesis process and requires organic solvents, reducing agents (e.g. H₂ in Langmuir 2000, 16, 7109; NaBH₄ in WO2011023897 and EP0796147B1) and further immobilization of the colloid onto the supporting oxides, and hence is rather complicated and generally unsuited for industrial application.

U.S. Pat. No. 4,513,098 discloses a process for the preparation of multimetallic TM catalysts with high dispersion on Silica and Alumina from organometallic precursors. The precursors selectively interact with surface hydroxyl groups on the oxide supports to achieve a uniform distribution of metal complexes. However, the precursors have to be dissolved in organic solvents under Argon and further to be reduced, e.g. at 600° C. for 16 h under H₂.

U.S. Pat. No. 6,806,224 describes a method for producing a supported metal catalyst with high dispersion, comprising of reducing a metal halide in the liquid phase in the presence of a support, an ammonium organic base and a reducing agent, such as alcohols, formaldehyde and hydrazine hydrate.

U.S. Pat. No. 7,381,681 discloses a process for preparation of Pt supported on SBA-150 Alumina with an average Pt particle diameter of 3.17 nm by reduction of Pt(NO₃)₂ with N₂H₄ in aqueous solution.

JP2008-259993 A provide for a process to prepare catalysts on gold basis. A volatile methyl gold diketonate complex is mixed with inorganic oxides at elevated temperatures to produce nano-scale gold particles on and in the inorganic oxide. The organometallic gold compound is said to be harmful to skin and, hence, is disadvantageously used in production on large scale.

Mohamed et al. disclose a process for distributing iron on and in certain zeolites. They suggest to use an cyclopetadienyl iron dicarbonyl complex in a CVD process to deposit the iron on the carrier material.

TWC containing rhodium, platinum and palladium as catalytically active metals on inorganic oxides. This process is an impregnation kind of process.

Hence despite a considerable body of work in the field there still remains a need in the art to discover or develop a process which produces metal deposited powders with high metal dispersion and which should be rather easy to handle and should help to obtain the final products in a reliable, safe and nonetheless advantageous manner viewed especially from an ecological and economical perspective.

These and other objectives known to those skilled in the art are met by applying a process according to the present claims. For the production of a material according to the invention a process deems favourable which furnishes a highly dispersed transition metal or metals deposition on refractory oxides, comprising the steps of:
i) providing a dry intimate mixture of a refractory oxide with one or more precursor compound or compounds comprising a complex formed out of a transition metal and one or more ligands, the complex decomposing to yield the metal or metal ion at temperatures between 100° C. and 500° C.; and
ii) calcining the mixture at a temperature and a time sufficient to decompose the metal precursor; and
iii) obtaining the supported oxide.

This process leads to a rather active catalyst comprising a highly dispersed distribution of the transition metal(s) on the refractory oxide. Accordingly, the transition metal deposits, formed by the aforementioned method, on the refractory oxide are smaller in particle size and thus more catalytically active. This in turn serves to minimize the transition metal content whilst still achieving activities comparable with catalysts known in the art or to provide better catalysts having comparable transition metal content. In addition, the process of the invention is conducted totally in a dry state, thus obviating the necessity of the use of or subsequent removal of a solvent which is advantageous from a handling point of view as well as from the perspective of safety issues.

The metals employed in this process are transition metals (TM). These metals are deposited onto refractory oxides to give a catalytically active material which in turn is part of catalysts or catalyst systems of, e.g. automotive vehicles. Such catalysts are e.g. Diesel oxidation catalysts (DOC), three-way catalysts (TWC), lean NOx traps (LNT), selective catalytic reduction (SCR), catalysed diesel particulate filter or the like or alternatively catalysts employed in bulk chemical processes e.g. hydrogenation/dehydrogenation, selective oxidation and the like. Preferably, metals used in this invention are selected from the group consisting of Pd, Pt, Rh, Ir, Ru, Ag, Au, Cu, Fe, Mn, Mo, Ni, Co, Cr, V, W, Nb, Y, Ln (lanthanides) or mixtures thereof. Most preferred the metals Pd, Pt and/or Rh are used in this respect.

In the present process a complex of one or more transition metal(s) and one or more ligands is used to give the highly dispersed deposit of such metal onto the refractory oxide. In order to provide the metal or metal ion onto this oxide the precursor compound preferably employed may show a modest volatility and an appropriate decomposition temperature, e.g. the complex is decomposing to yield the metal or metal ion at temperatures between 100° C. and 500° C., preferably 200° C.-450° C., which may have a structure of formula I:

ML¹ₘL²ₙ (I),

wherein:

M is a metal chosen from the group mentioned above.

L¹ may be carbonyl, amine, alkene, arene, phosphine or other neutral coordinating ligand. L² may be acetate, alkoxy or advantageously embraces a diketonate, ketoiminato or related member of this homologous series like a ligand of formula II:

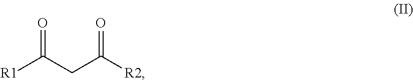

wherein:

R1 and R2 are independently alkyl, substituted alkyl, aryl, substituted aryl, acyl and substituted acyl.

In formula I, m can be a number ranging from 0 to 6, n may take a number equal to the valence of M and m+n is not less than 1.

Preferably the complex ligand is selected from the group consisting of a diketonate-structure, carbonyl species, acetates, alkenes and mixtures thereof.

Precursor compounds comprising a complex formed out of such a metal or metal ion and a ligand are known to the artisan. Further details regarding these compounds and their production can be found in: Fernelius and Bryant Inorg Synth 5 (1957) 130-131, Hammond et al. Inorg Chem 2 (1963) 73-76, WO2004/056737 A1 and references therein. Further ligands in complexed form embracing a diketonate-structure are also known in the prior art, as exemplified in Finn et al. J Chem Soc (1938) 1254, Van Uitert et al. J Am Chem Soc 75 (1953) 2736-2738, and David et al. J Mol Struct 563-564 (2001) 573-578. Preferable structures of these types of ligands can be those selected from the group consisting of R1 and R2 in formula II as alkyls. More preferably these ligands are selected from the group consisting of R1 and R2 as methyl or tert-butyl; most preferred is acetylacetonate (acac, R1 and R2 in II are methyl groups).

When low-valent metal compounds are employed, the carbonyl complexes stable at room temperature are preferred, considering their moderate volatility and decomposition temperatures mentioned above. The syntheses of such compounds are well known and generally carried out by reducing a metal salt in the present of CO. Further details regarding these compounds and their preparation can be found in: Abel Quart Rev 17 (1963) 133-159, Hieber Adv Organomet Chem 8 (1970) 1-28, Abel and Stone Quart Rev 24 (1970) 498-552, and Werner Angew Chem Int Ed 29 (1990) 1077.

As mentioned above the precursor compounds deployed are deposited onto refractory oxides. The skilled worker is highly familiar with appropriate refractory oxides to be used in generating catalyst for the application in question. Preferably the refractory oxides are selected from the group consisting of transition Aluminas, heteroatom doped transition Aluminas, Silica, Ceria, Zirconia, Ceria-Zirconia based solid solutions, Lanthanum oxide, Magnesia, Titania, Tungsten oxide and mixtures thereof. More preferably oxides like Alumina, Ceria and Zirconia based oxides or mixtures thereof are employed. Most preferred Aluminas that may be employed in this invention include γ-Al₂O₃, δ-Al₂O₃, θ-Al₂O₃, or other transition Alumina. Additionally the Alumina could be modified e.g. by the inclusion of heteroatomic species with cationic doping, e.g. Si, Fe, Zr, Ba, Mg or La.

In the current invention the precursor compounds and the refractory oxides need to be thoroughly mixed. When not mixed well, a poor distribution of the transition metal on the refractory oxides can be caused. An intimate mixture of the materials in this work can be realized according to the artisan (Fundamentals of Particle Technology, Richard G. Holdich, 2002, p 123; Powder Mixing (Particle Technology Series), B. H. Kaye, 1997, p 1.). Preferably, this is realised by homogenising the materials in a closed bottle with a rotation mixer. The grinding beads can be added to enhance the mixing quality, which, however, should be chemically and thermally stable to avoid the contamination of the samples. Mixer or blender for powders is one of the oldest known operation units in the solids handling industries. The known mixing device by physical forces, either impact forces or shear forces, can be used here. A certain mixing time is required to attain a uniform mixing. Hence, it is preferable that the mixture comprises 0 to 40 wt % grinding beads and is rotated for 1-60 mins, preferably 1-50 mins. More preferably the amount of grinding beads should be in the range of about 2 to 30 wt % with a roation time of 2-30 mins. Most preferably the mixture includes 5 to 20 wt % grinding beads and is rotated for 3-15 mins.

The intimate mixture of refractory oxides and precursor compound subsequently has to be heated in order to decompose the complexed metal and deposit onto the surface of the refractory oxide. The skilled worker is again familiar with applicable temperature ranges most preferably applied to reach this goal. To enable this one should balance the temperature sufficiently to enable the decomposition of the precursor compound to initiate and facilitate mobilisation of the metal or metal ion whilst ensuring the temperature is not so excessive as to engender sintering both of the oxide or the metal particles or compounds deposited thereon. Thus this calcination preferably takes place at temperatures of above 200° C. In a preferred embodiment the mixture is calcined at a temperature of 200-650° C. Most preferred a temperature between 250 and 450° C. is applied. It should be stressed that the process described in the current invention is not reliant upon reduced pressure or specific reaction gases and may be executed under a static or flowing gas e.g. air or inert gas like N₂ or a reducing atmosphere comprising e.g. about 0.5% to 5% H₂ without compromise to the performance of the final catalyst. Advantageously, a process of the present invention works without using a solvent while providing a dry intimate mixture of a refractory oxide with one or more precursor compound or compounds comprising a complex formed out of the transition metal and respective ligands. In addition, calcining the mixture is preferably performed without reduced pressure and without the presence of specific reaction gases that react with the complex by reducing it. In particular this holds true for a complex where the ligand is selected from the group consisting of a diketonate-structure, carbonyl species, acetates, alkenes and mixtures thereof.

In addition it should be noted that the duration of the calcination or heating procedure should occur within an appropriate range. The high temperature exposure of the mixture may typically last up to 12 hours. Preferably the thermal treatment comprises a time of 1 min-5 hours. In a very preferred manner the mixture is exposed to the high temperature treatment as depicted above. Advantageously, the mixture is exposed to temperatures of 250-450° C. for 10 mins-4 hours. Most preferred the process is performed around 350° C. for a period of 15 to 120 minutes.

In order to ensure that the catalytically required concentration of the metal deposits onto the oxide is achieved, specific ratios of both ingredients should be present in the mixture. Hence, it is preferable that the mixture comprises the oxide and the precursor compound such that decomposition of the precursor results in a metal concentration onto the refractory oxide of about 0.01 wt % metal to about 20 wt % metal, preferably 0.05-14 wt %. More preferably the metal concentration onto the oxide should be in the range of about 0.1 to 8 wt %. Most preferably the metal concentration should be from about 0.5 to about 2.5 wt %.

A second embodiment of the present invention is directed to a material or mixture of materials obtainable according to the process of the invention, wherein the material or mixture of materials can be applied in the field of catalysis, e.g. to the abatement of noxious substances in the exhaust of a combustion engine as an application example.

In a further aspect the present invention is directed to a catalyst comprising the material or mixture of materials obtained according to a process of the present invention. Preferably the catalyst may comprise further inert refractory binders selected from the group consisting of Alumina, Titania, non-Zeolitic Silica-Alumina, Silica, zirconia and mixtures thereof and is coated on a substrate, e.g. a flow through ceramic monolith, metal substrate foam or on a wall-flow filter substrate. In a more preferable way the catalyst described above is produced in a manner, wherein the material or mixture of materials described above and the binder are coated in discrete zones on a flow through ceramic monolith, metal substrate foam or on a wall-flow filter substrate.

In still a further aspect the present invention is directed to a monolith catalyst formed via extrusion of the material or mixture of materials according to a process of the present invention. It is needless to say that further necessary materials known to the artisan may be co-extruded as well to build up the extruded monolith.

A different embodiment of the present invention concerns the use of a material, catalyst or monolith catalyst as presented above. As it turns out that the present process serves to generate a totally new material with certain characteristics its use may be proposed for the whole are of catalysis. In particular the present product may be applied to heterogeneously catalyzed chemical reactions selected from the group consisting of hydrogenation, C—C-bond formation or cleavage, hydroxylation, oxidation, reduction. In the alternative mentioned materials can be used preferably for the abatement of exhaust pollutants. Such pollutants can be those selected from the group consisting of CO, HC (in form of SOF or VOF), particulate matter or NOx. Applications in this respect are already state of the art and known to the artisan e.g. Regulation (EC) No 715/2007 of the European Parliament and of the Council, 20 Jun. 2007, Official Journal of the European Union L 171/1, see also Twigg, Applied Catalysis B, vol. 70 p 2-25 and R. M. Heck, R. J. Farrauto Applied Catalysis A vol. 221, (2001), p 443-457 and references therein. The materials, catalysts and monoliths of the present invention may be employed likewise.

Normally, the material or mixture of materials produced according to the process of the invention is present as a catalytic device which comprises a housing disposed around a substrate upon which the catalyst comprising the material or mixture of materials is disposed. Also, the method for treating the off-gas of a combustion exhaust or fossil fuel combustion exhaust stream can comprise introducing the said exhaust stream to such a catalyst for abating the regulated pollutants of said exhaust stream.

The material or mixture of materials can be included in the formulation by combining them with other auxiliary compounds known to the artisan like Alumina, Silica, Zeolites or Zeotypes or other appropriate binder and optionally with other catalyst materials e.g. Ce-based oxygen storage component to form a mixture, drying (actively or passively), and optionally calcining the mixture. More specifically, a slurry may be formed by combining the material of the invention with auxiliary materials and water, and optionally pH control agents e.g. inorganic or organic acids and bases and/or other components. This slurry can then be wash-coated onto a suitable substrate. The wash-coated product can be dried and heat treated to fix the washcoat onto the substrate.

This slurry produced from the above process can be dried and heat treated, e.g. at temperatures of ca. 250° C. to ca. 1000° C., or more specifically about 300° C. to about 600° C., to form the finished catalyst formulation. Alternatively, or in addition, the slurry can be wash-coated onto the substrate and then heat treated as described above, to adjust the surface area and crystalline nature of the support.

The catalyst obtained comprises a refractory oxide supported metal by the method disclosed herein. The catalyst may additionally comprise a further inert refractory binder material. The supported catalyst can subsequently be disposed on a substrate. The substrate can comprise any material designed for use in the desired environment. Possible materials include cordierite, silicon carbide, metal, metal oxides (e.g., Alumina, and the like), glasses and the like, and mixtures comprising at least one of the foregoing materials. These materials can be in the form of packing material, extrudates, foils, perform, mat, fibrous material, monoliths e.g. a honeycomb structure and the like, wall-flow monoliths (with capability for diesel particulate filtration), other porous structures e.g., porous glasses, sponges, foams, and the like (depending upon the particular device), and combinations comprising at least one of the foregoing materials and forms, e.g., metallic foils, open pore Alumina sponges, and porous ultra-low expansion glasses. Furthermore, these substrates can be coated with oxides and/or hexaAluminates, such as stainless steel foil coated with a hexaAluminate scale. Alternatively the refractory oxide supported metal or metal ion may be extruded, with appropriate binders and fibres, into a monolith or wall-flow monolithic structure.

Although the substrate can have any size or geometry the size and geometry are preferably chosen to optimise geometric area in the given exhaust emission control device design parameters. Typically, the substrate has a honeycomb geometry, with the combs through-channel having any multisided or rounded shape, with substantially square, triangular, pentagonal, hexagonal, heptagonal, or octagonal or similar geometries preferred due to ease of manufacturing and increased surface area.

Once the supported catalytic material is on the substrate, the substrate can be disposed in a housing to form the converter. The housing can have any design and comprise any material suitable for application. Suitable materials can comprise metals, alloys, and the like, such as ferritic stainless steels (including stainless steels e.g. 400-Series such as SS-409, SS-439, and SS-441), and other alloys (e.g. those containing nickel, chromium, aluminium, yttrium and the like, to permit increased stability and/or corrosion resistance at operating temperatures or under oxidising or reducing atmospheres).

Also similar materials as the housing, end cone(s), end plate(s), exhaust manifold cover(s), and the like, can be concentrically fitted about the one or both ends and secured to the housing to provide a gas tight seal. These components can be formed separately (e.g., moulded or the like), or can be formed integrally with the housing using methods such as, e.g., a spin forming, or the like.

Disposed between the housing and the substrate can be a retention material. The retention material, which may be in the form of a mat, particulates, or the like, may be an intumescent material e.g., a material that comprises vermiculite component, i.e., a component that expands upon the application of heat, a non-intumescent material, or a combination thereof. These materials may comprise ceramic materials e.g., ceramic fibres and other materials such as organic and inorganic binders and the like, or combinations comprising at least one of the foregoing materials.

Thus, the coated monolith with supported catalytic material is incorporated into the exhaust flow of the combustion engine. This provides a means for treating said exhaust stream to decrease concentrations of regulated pollutants including CO, HC, and oxides of nitrogen by passing said exhaust stream over the aforementioned catalyst under appropriate conditions.

The present invention relates to the development and use of an improved method for the production of supported catalytic material and their application to the remediation of noxious substances from combustion engines. The method is further characterised in that it employs a dry i.e. non aqueous (or other solvent based) process in which the metals or metal ions are deposited onto the refractory oxide material by decomposition of an appropriate metal precursor e.g. diketonate, specific Carbonyl complexes or similar as part of an intimate mixture of a precursor compound and the refractory oxide. The process is yet further characterised by its robust nature in that it does not require specific reactive gas environment and reduced pressure. It provides for the formation of the desired supported catalytic material, which is also a part of the present invention, without the generation of significant harmful or toxic waste by-products.

Benefits and features include:
a) Simplicity: the process comprises an intimate mixing of two or more dry powders followed by high temperature treatment. There is no need for complex mixing units or slurry handling systems. The dry process obviates any requirement for (organic) solvents, slurry filtration, washing or drying. Moreover the process is insensitive with regard to the atmosphere or reactor pressure used during calcination. This is an advantage over the prior art in that neither a protective nor a reductive gas has to be applied.
b) Cost: Material savings arise from the simplicity of the synthesis without recourse to the equipment and process described in a). Further savings arise from the removal of monitoring equipment of slurry pH and temperature etc.
c) Time: production of the finished powder can be complete in as a little as 2 hours unlike the multiple-day requirements of conventional wet exchange or the many hour requirements of slurry impregnation/calcination (mixing time to ensure homogeneity, limit contribution of exotherm of wetting of refractory oxides on slurry chemistry etc.).
d) Decreased Environmental Impact: Unlike the processes of the prior art the current process limits by-product generation to stoichiometric quantities of CO₂ and H₂O from decomposition of the precursor ligands. There is no generation of extensive aqueous waste streams, as with ion exchange, nor the generation of potentially toxic emissions e.g. HF or HCl gas as seen for solid state ion exchange or N-bearing compounds (organic amines or Nitrogen oxides) as noted for the slurry impregnation/calcination method (from combustion of NH₃ or organo-nitrogen bases used in slurry pH control/metal precipitation). Moreover given the stoichiometric nature of the preparation there is no excess material or additional chemicals required to produce the catalyst, decreasing the environmental impact to a minimum.
e) More robust and flexible method for dopant introduction: Dopant targeting requires simple calculation for loss of ignition of precursor materials. The absence of any additional chemical species or processes decreases any stacked tolerances to the absolute minimum.
f) Performance benefits: Unlike the conventional slurry impregnation/calcination process the method/material of the invention introduces the metal directly onto the surface of a refractory oxide. Highly dispersed metal deposited on supports are achieved. In addition given the increased efficiency of the metal precipitation method there is no need to ‘overload’ the refractory oxide to obtain the ‘full’ metal deposition required for the optimal performance. This provides an improvement in catalyst selectivity. Secondly, improved durability/aging stability of metal containing refractory oxides is realised as the decreased metal load per surface unit limits high temperature (>750° C.) solid state reactions between the metals, a primary cause of reduced activity of the aged catalyst. Finally, the dry process removes the need for slurry pH or rheology modifiers.

### DEFINITIONS

It should be further noted that the terms “first”, “second” and the like herein do not denote any order of importance, but rather are used to distinguish one element from another, and the terms “a” and “an” herein do not denote a limitation of quantity, but rather denote the presence of at least one of the referenced items. Furthermore, all ranges disclosed herein are inclusive and combinable e.g., ranges of “up to about 25 weight percent (wt %), with about 5 wt % to about 20 wt % desired, and about 10 wt % to about 15 wt % more desired” is inclusive of the endpoints and all intermediate values of the ranges, e.g. “about 5 wt % to about 25 wt %, about 5 wt % to about 15 wt %” etc.

Diketonate-structured ligands: Implying a ligand i.e. an ion or molecule that binds to a central metal-atom forming a coordination complex that possesses two sets of chemical functionality exhibiting Keto-Enol forms. Herein Keto i.e. Ketone/Aldehyde (carbonyl or C═O bearing hydrocarbon)-Enol (unsaturated alcohol i.e. C═C—OH) forms are derived from organic chemistry. A key characteristic of Keto-Enol systems is they exhibit a property known as tautomerism which refers to a chemical equilibrium between a Keto form and an Enol involving the interconversion of the two forms via proton transfer and the shifting of bonding electrons.

Intimate mixture of the precursor compounds and the refractory oxides denotes a process in which the materials applied are mixed in a container followed by homogenisation by physical forces.

The above-described catalyst and process and other features will be appreciated and understood by those skilled in the art from the following detailed description, drawings, and appended claims.

The following set of data include a diverse range of preparation examples employing different metal loads, metal precursors and process variations as an illustration of the flexibility of the metal deposition method for supported catalyst preparation. Direct comparison versus conventional preparation method (incipient wetness impregnation) is made to illustrate the benefits of the new method.

### EXAMPLES

The following non-limiting examples and comparative data illustrate the present invention.

Raw materials with the following properties were used to prepare the exemplary samples and comparative reference samples to explain the invention in more detail.

### Starting Materials for the Exemplary Samples in the Current Invention:

Pt(acac)₂: Platinum(II) acetylacetonate;

Pd(acac)₂: Palladium(II) acetylacetonate;

Pd(OAc)₂: Palladium(II) acetate;

Pd(tmhd)₂: Bis(2,2,6,6-tetramethyl-3,5-heptanedionato)palladium(II);

Rh(acac)₃: Rhodium(III) acetylacetonate;

Rh(CO)₂(acac): Dicarbonylacetylacetonato rhodium(I);

Ru₃(CO)₁₂: Ruthenium carbonyl;

Ru(acac)₃: Ruthenium(III) acetylacetonate;

Fe(acac)₃: Iron(III) acetylacetonate;

Ag(acac): Silver(I) acetylacetonate;

Cu(acac)₂: Copper(II) acetylacetonate.

Starting materials for the comparative reference samples:

EA-Pt: Ethanol amine hexahydroxy platinic(III) acid;

Pd(NO₃)₂: Palladium(II) nitrate;

Rh(NO₃)₃: Rhodium(III) nitrate;

Ru(NO)(NO₃)₃: Ruthenium(III) nitrosyl nitrate;

AgNO₃: Silver(I) nitrate;

Cu(NO₃)₂: Copper(II) nitrate;

Fe(NO₃)₃: Iron(III) nitrate;

### Refractory Oxides:

γ-Al₂O₃: gamma-aluminium oxide, BET surface area: 150 m²/g;

La/Al₂O₃: gamma-aluminium oxide stabilized with 4 wt % of lanthanum oxide, BET surface area: 150 m²/g;

CYZ: coprecipitated Cerium/Zirconium/Yttrium mixed oxide with a weight ratio of 30/60/10, BET surface area: 70 m²/g.

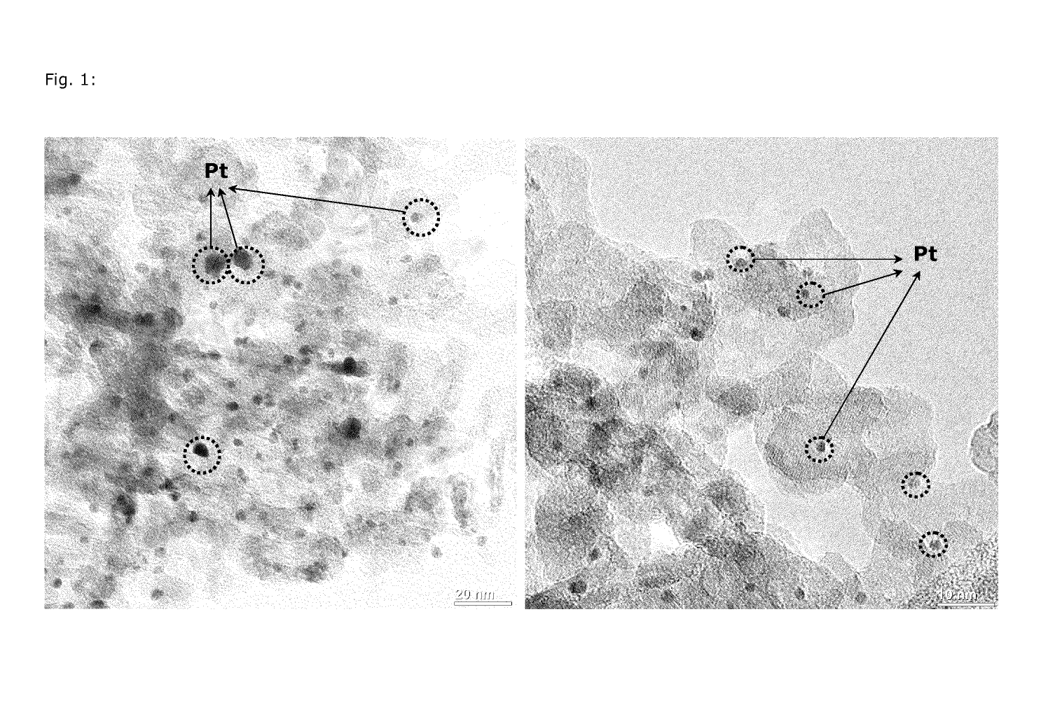

According to the present invention highly dispersed metal nanoparticles on supports are prepared. Some examples are illustrated in FIG. 1-8 and summarised in Table 1 and 2.

FIG. 1 TEM images of 2 wt % Pt/Al₂O₃ prepared by IWI (left, scale bar 20 nm) and new deposition method (right, scale bar 10 nm). Refer to Comparative Reference Sample 2 and Example 2, respectively.

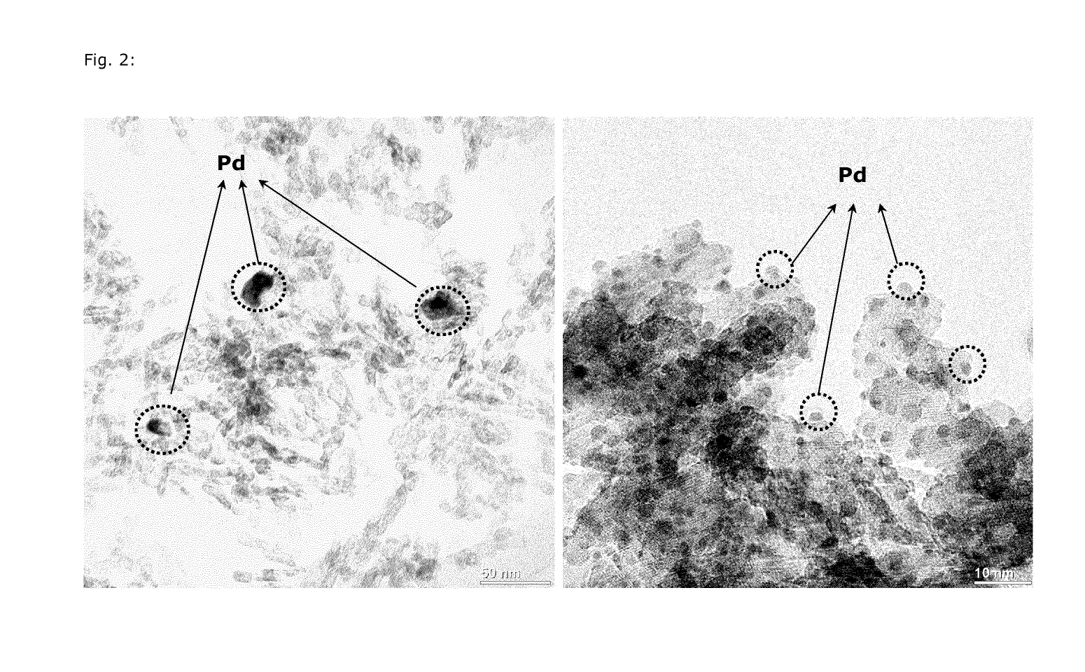

FIG. 2 TEM images of 2 wt % Pd/Al₂O₃ prepared by IWI (left, scale bar 50 nm) and new deposition method (right, scale bar 10 nm). Refer to Comparative Reference Sample 3 and Example 7, respectively.

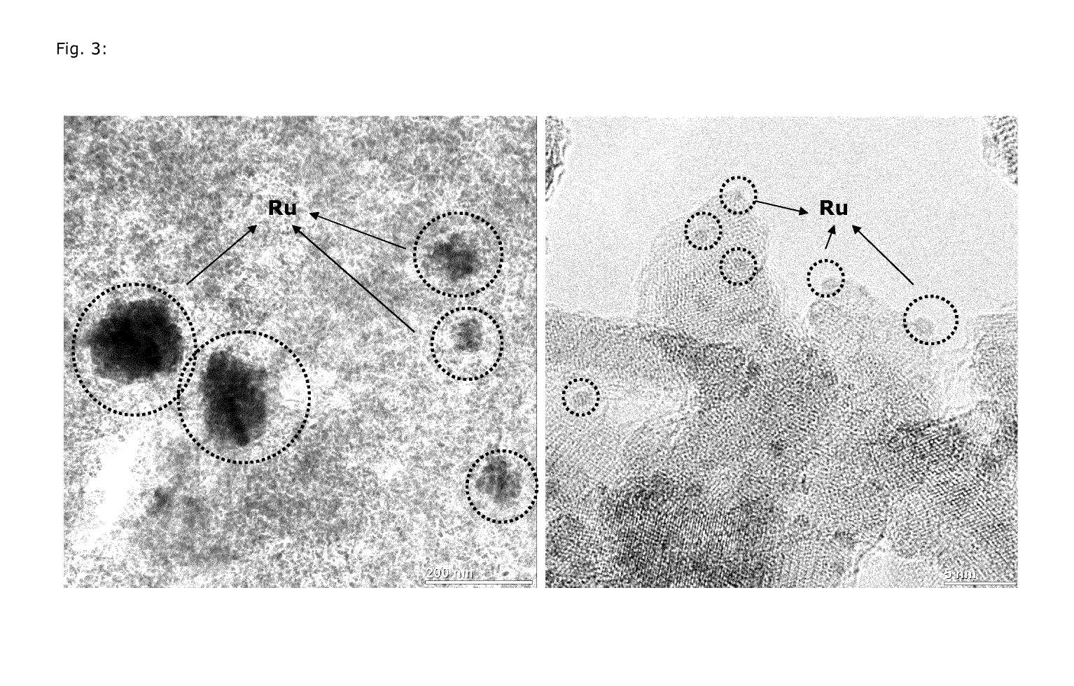

FIG. 3 TEM images of 2 wt % Ru/Al₂O₃ prepared by IWI (left, scale bar 200 nm) and new deposition method (right, scale bar 5 nm). Refer to Comparative Reference Sample 6 and Example 17, respectively.

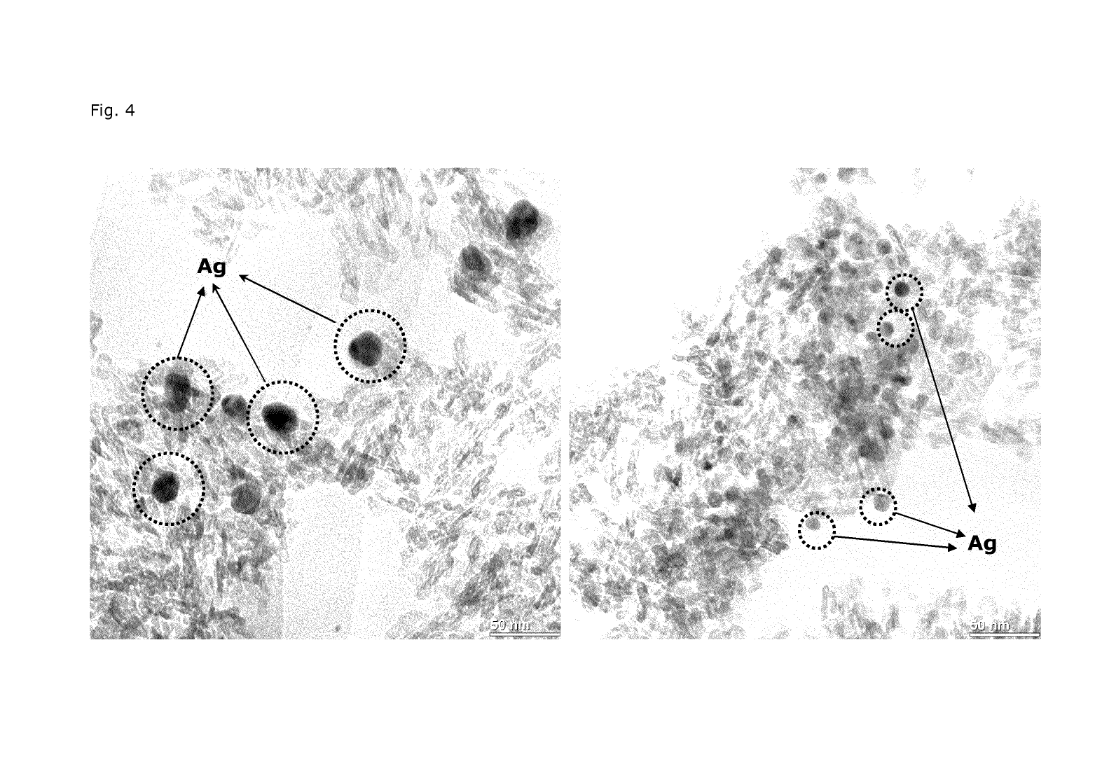

FIG. 4 TEM images of 1 wt % Ag/Al₂O₃ prepared by IWI (left, scale bar 50 nm) and new deposition method (right, scale bar 50 nm). Refer to Comparative Reference Sample 7 and Example 23, respectively.

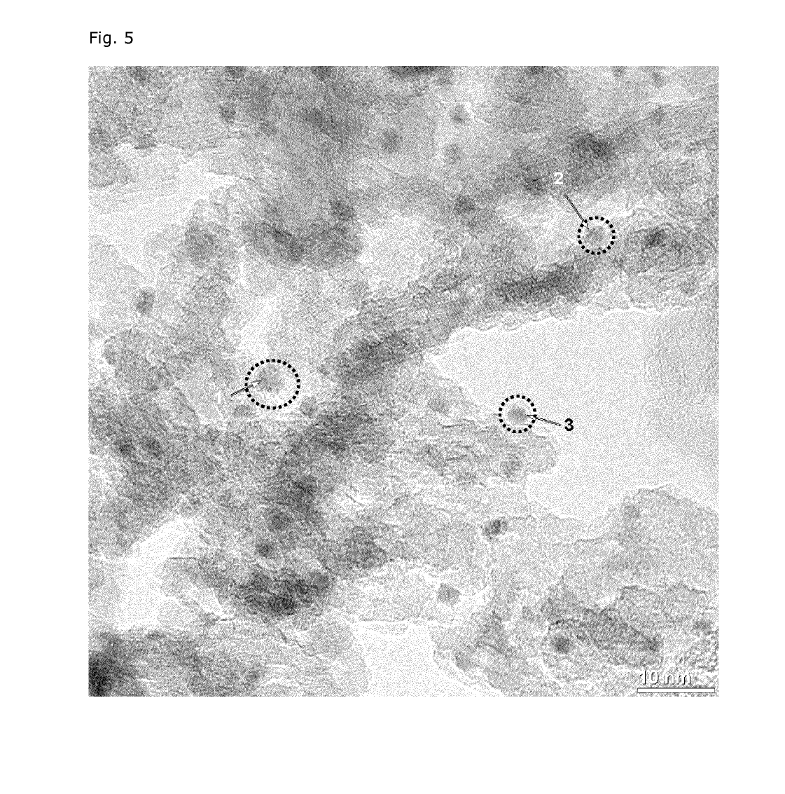

FIG. 5 TEM images of PtPd/Al₂O₃ prepared by the new deposition method (Example 19). EDX of Pt/Pd wt ratio in particle 1-3: 0.85, 1.00, 0.75. The scale bar is 10 nm.

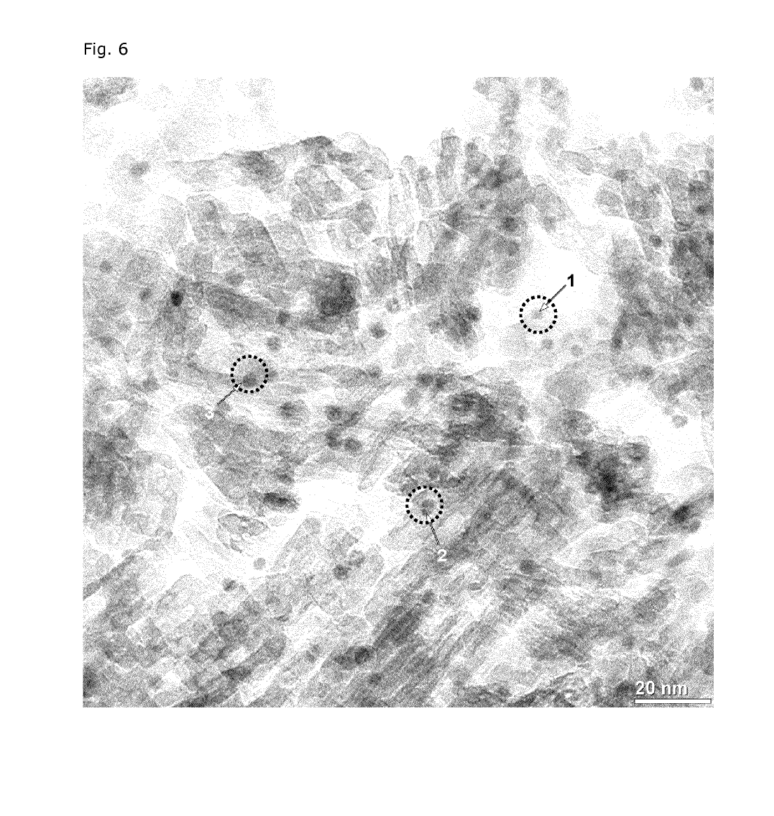

FIG. 6 TEM images of RhPd/Al₂O₃ prepared by the new deposition method (Example 22). EDX of Rh/Pd wt ratio in particle 1-3: 1.16, 1.54, 2.11. The scale bar is 20 nm.

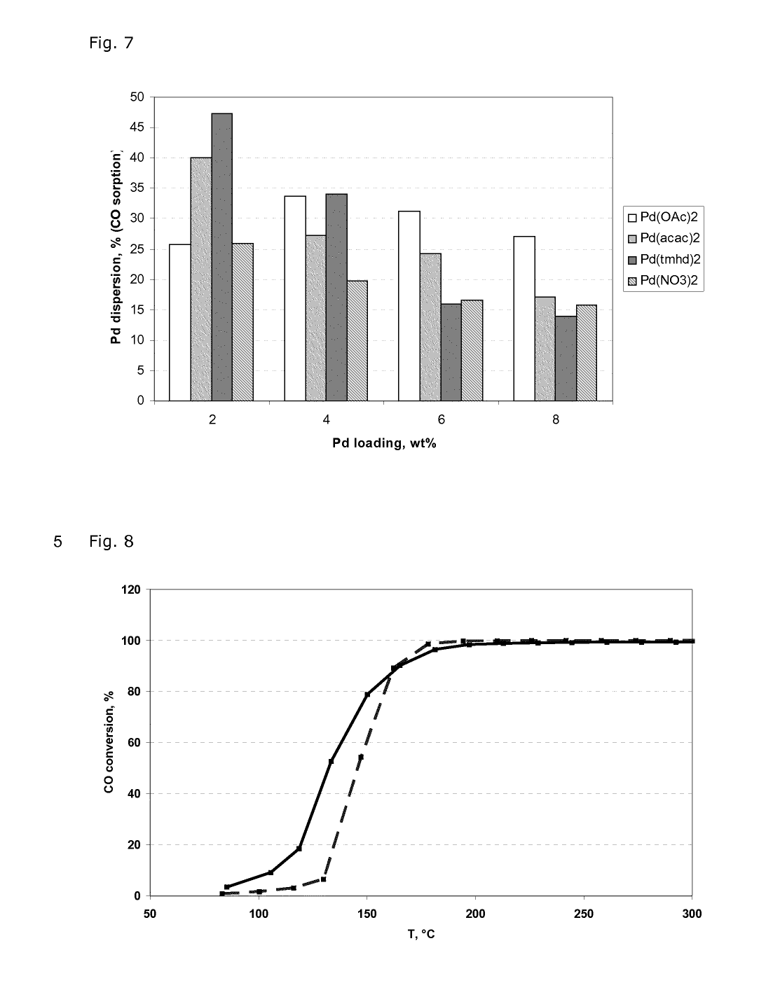

FIG. 7 Summary of CO chemisorption results in Table 2.

FIG. 8 CO oxidation activity of 0.5 wt % Pt/Al2O3 powders prepared by incipient wetness impregnation (Broken line; Comparative Reference sample 1) and the new deposition method (Solid line; Example 1). The T50 values i.e. the temperatures required for 50% CO oxidation, of the two powders are 147° C. and 133° C., respectively. The activity data of CO oxidation was shown in FIG. 8. The light off temperature of the sample prepared by the new deposition method (Example 1) is 14° C. lower than that prepared by conventional incipient wetness impregnation.

TABLE 1
Supported metal nanoparticles prepared by incipient wetness impregnation
(IWI) and the new deposition method (DM) described in the present
invention.

| | | | | | | | | Analyses of product | |
|---|---|---|---|---|---|---|---|---|---|
| | | | Metal | | Calcination | | | Metal | Particle |
| | | Support | loading, | | | T, | t, | loading, | size, nm |
| Samples | Metal Precursors | oxide | wt % | Process | Gas | ° C. | min | wt % (ICP) | (TEM) |
| Ref1 | EA-Pt | γ-Al₂O₃ | 0.5 | IWI | Air | 500 | 120 | 0.53 | 1-6 |
| Ref2 | EA-Pt | γ-Al₂O₃ | 2 | IWI | Air | 500 | 120 | 2.01 | 1-8 |
| Ref3 | Pd(NO₃)₂ | γ-Al₂O₃ | 2 | IWI | Air | 500 | 120 | 1.92 | 10-30 |
| Ref4 | Rh(NO₃)₃ | γ-Al₂O₃ | 2 | IWI | Air | 500 | 120 | 2.04 | 1-15 |
| Ref5 | Ru(NO)(NO₃)₃ | γ-Al₂O₃ | 2 | IWI | Air | 500 | 240 | 1.74 | 100-600 |
| Ref6 | Ru(NO)(NO₃)₃ | γ-Al₂O₃ | 2 | IWI | N2 | 500 | 240 | 1.44 | 50-200 |
| Ref7 | AgNO₃ | γ-Al₂O₃ | 1 | IWI | Air | 500 | 240 | 1.03 | 10-30 |
| Ref8 | Cu(NO₃)₂ | γ-Al₂O₃ | 1 | IWI | N2 | 500 | 240 | 1.02 | <1 |
| Ref9 | Cu(NO₃)₂ | CYZ | 1 | IWI | Air | 500 | 240 | 0.92 | 1-2 |
| Ref10 | Fe(NO₃)₃ | CYZ | 1 | IWI | Air | 500 | 240 | 0.90 | <1 |
| 1 | Pt(acac)₂ | γ-Al₂O₃ | 0.5 | DM | N2 | 450 | 120 | 0.50 | <1.5 |
| 2 | Pt(acac)₂ | γ-Al₂O₃ | 2 | DM | N2 | 450 | 120 | 2.01 | 1-2 |
| 5 | Pd(acac)₂ | γ-Al₂O₃ | 0.5 | DM | Air | 300 | 120 | 0.45 | 1.5-4 |
| 6 | Pd(acac)₂ | CYZ | 2 | DM | Air | 300 | 120 | 1.96 | <3 |
| 7 | Pd(OAc)₂ | γ-Al₂O₃ | 2 | DM | Air | 350 | 120 | 1.86 | 1-4 |
| 8 | Pd(OAc)₂ | CYZ | 2 | DM | Air | 300 | 120 | 2.00 | <2 |
| 9 | Pd(acac)₂ | γ-Al₂O₃ | 2 | DM | Air | 300 | 120 | 1.87 | 2-5 |
| 10 | Rh(acac)₃ | γ-Al₂O₃ | 0.5 | DM | Air | 300 | 120 | 0.52 | 2-4 |
| 11 | Rh(acac)₃ | γ-Al₂O₃ | 0.5 | DM | N2 | 450 | 120 | 0.53 | <1.5 |
| 12 | Rh(CO)₂(acac) | γ-Al₂O₃ | 0.5 | DM | N2 | 450 | 120 | 0.46 | <2 |
| 13 | Rh(acac)₃ | γ-Al₂O₃ | 2 | DM | N2 | 450 | 120 | 1.87 | 2-4 |
| 14 | Rh(CO)₂(acac) | γ-Al₂O₃ | 2 | DM | N2 | 450 | 120 | 2.00 | <4 |
| 15 | Rh(acac)₃ | CYZ | 2 | DM | Air | 500 | 120 | 1.99 | <3 |
| 16 | Ru(acac)₃ | γ-Al₂O₃ | 2 | DM | N2 | 400 | 120 | 1.86 | 1-2 |
| 17 | Ru₃(CO)₁₂ | γ-Al₂O₃ | 2 | DM | N2 | 400 | 120 | 1.92 | 1-2 |
| 18 | Pd(acac)₂, | γ-Al₂O₃ | Pd: 1 | DM | Air | 500 | 120 | Pd: 0.93 | 2-6 |
| | Rh(acac)₃ | | Rh: 1 | | | | | Rh: 1.04 | |
| 19 | Pt(acac)₂, | γ-Al₂O₃ | Pt: 1 | DM | N2 | 500 | 120 | Pt: 1.07 | 2-3 |
| | Pd(acac)₂ | | Pd: 1 | | | | | Pd: 0.96 | |
| 20 | Pt(acac)₂, | γ-Al₂O₃ | Pt: 1 | DM | N2 | 500 | 120 | Pt: 0.97 | 1-3 |
| | Fe(acac)₃ | | Fe: 1 | | | | | Fe: 1.02 | |
| 21 | Rh(acac)₃, | γ-Al₂O₃ | Rh: 1 | DM | N2 | 500 | 120 | Rh: 0.88 | 3-5 |
| | Fe(acac)₃ | | Fe: 1 | | | | | Fe: 1.02 | |
| 22 | Rh(acac)₃, | γ-Al₂O₃ | Rh: 1 | DM | N2 | 500 | 120 | Rh: 1.11 | 2-5 |
| | Pd(acac)₂ | | Pd: 1 | | | | | Pd: 0.96 | |
| 23 | Ag(acac) | γ-Al₂O₃ | 1 | DM | Air | 500 | 60 | 0.87 | 5-10 |
| 24 | Cu(acac)₂ | γ-Al₂O₃ | 1 | DM | N2 | 500 | 60 | 0.97 | <1 |
| 25 | Cu(acac)₂ | CYZ | 1 | DM | Air | 400 | 30 | 0.87 | <1 |
| 26 | Fe(acac)₃ | CYZ | 1 | DM | Air | 400 | 30 | 0.87 | <1 |

TABLE 2
Further examples of supported Pd nanoparticles prepared by incipient
wetness impregnation (IWI) and the new deposition method (DM) described
in the present invention.

| | | | | | | | | Product | |
|---|---|---|---|---|---|---|---|---|---|
| | | | Metal | | Calcination | | | Metal | Pd dispersion, |
| | Metal | Support | loading, | | | T, | t, | loading, | % (CO |
| Samples | Precursors | oxide | wt % | Process | Gas | ° C. | mins | wt % (ICP) | chemisorption) |
| Ref11 | Pd(NO₃)₂ | La/Al₂O₃ | 2 | IWI | Air | 550 | 240 | 1.97 | 25.9 |
| Ref12 | Pd(NO₃)₂ | La/Al₂O₃ | 4 | IWI | Air | 550 | 240 | 3.86 | 19.7 |
| Ref13 | Pd(NO₃)₂ | La/Al₂O₃ | 6 | IWI | Air | 550 | 240 | 5.71 | 16.6 |
| Ref14 | Pd(NO₃)₂ | La/Al₂O₃ | 8 | IWI | Air | 550 | 240 | 7.62 | 15.8 |
| 27 | Pd(OAc)₂ | La/Al₂O₃ | 2 | DM | Air | 450 | 120 | 1.85 | 25.8 |
| 28 | Pd(OAc)₂ | La/Al₂O₃ | 4 | DM | Air | 450 | 120 | 3.86 | 33.7 |
| 29 | Pd(OAc)₂ | La/Al₂O₃ | 6 | DM | Air | 450 | 120 | 5.61 | 31.2 |
| 30 | Pd(OAc)₂ | La/Al₂O₃ | 8 | DM | Air | 450 | 120 | 7.50 | 27 |
| 31 | Pd(acac)₂ | La/Al₂O₃ | 2 | DM | Air | 350 | 120 | 1.98 | 40 |
| 32 | Pd(acac)₂ | La/Al₂O₃ | 4 | DM | Air | 350 | 120 | 3.79 | 27.2 |
| 33 | Pd(acac)₂ | La/Al₂O₃ | 6 | DM | Air | 350 | 120 | 5.83 | 24.2 |
| 34 | Pd(acac)₂ | La/Al₂O₃ | 8 | DM | Air | 350 | 120 | 7.54 | 17.1 |
| 35 | Pd(tmhd)₂ | La/Al₂O₃ | 2 | DM | Air | 350 | 120 | 1.97 | 47.3 |
| 36 | Pd(tmhd)₂ | La/Al₂O₃ | 4 | DM | Air | 350 | 120 | 4.03 | 34 |
| 37 | Pd(tmhd)₂ | La/Al₂O₃ | 6 | DM | Air | 350 | 120 | 5.76 | 15.9 |
| 38 | Pd(tmhd)₂ | La/Al₂O₃ | 8 | DM | Air | 350 | 120 | 7.80 | 14 |

### Comparative Reference Sample 1:

0.5 wt % Pt on γ-Al₂O₃ (Table 1, Ref1)

The sample was prepared by incipient wetness impregnation of Alumina with an aqueous solution of EA-Pt, followed by drying in static air at 80° C. for 24 h and subsequent calcination for 2 hours at 500° C. in static air.

Physical characterisation: The particle size was determined by TEM: 1-6 nm; ICP-analysis: 0.53 wt % Pt.

### Comparative Reference Sample 2:

2 wt % Pt on γ-Al₂O₃ (Table 1, Ref2)

The sample was prepared by incipient wetness impregnation of Alumina with an aqueous solution of EA-Pt, followed by drying in static air at 80° C. for 24 h and subsequent calcination for 2 hours at 500° C. in static air.

Physical characterisation: The particle size was determined by TEM: 1-8 nm; ICP-analysis: 2.01 wt % Pt.

### Comparative Reference Sample 3:

2 wt % Pd on γ-Al₂O₃ (Table 1, Ref3)

The sample was prepared by incipient wetness impregnation of Alumina with an aqueous solution of Pd(NO₃)₂, followed by drying in static air at 80° C. for 24 h and subsequent calcination for 2 hours at 500° C. in static air.

Physical characterisation: The particle size was determined by TEM: 10-30 nm; ICP-analysis: 1.92 wt % Pd.

### Comparative Reference Sample 4:

2 wt % Rh on γ-Al₂O₃ (Table 1, Ref4)

The sample was prepared by incipient wetness impregnation of Alumina with an aqueous solution of Rh(NO₃)₃, followed by drying in static air at 80° C. for 24 h and subsequent calcination for 2 hours at 500° C. in static air.

Physical characterisation: The particle size was determined by TEM: 1-15 nm; ICP-analysis: 2.04 wt % Rh.

### Comparative Reference Sample 5:

2 wt % Ru on γ-Al₂O₃ (Table 1, Ref5)

The sample was prepared by incipient wetness impregnation of Alumina with an aqueous solution of Ru(NO)(NO₃)₃, followed by drying in static air at 80° C. for 24 h and subsequent calcination for 4 hours at 500° C. in static air.

Physical characterisation: The particle size was determined by TEM: 100-600 nm; ICP-analysis: 1.74 wt % Ru.

### Comparative Reference Sample 6:

2 wt % Ru on γ-Al₂O₃ (Table 1, Ref6)

The sample was prepared by incipient wetness impregnation of Alumina with an aqueous solution of Ru(NO)(NO₃)₃, followed by drying in static air at 80° C. for 24 h and subsequent calcination for 4 hours at 500° C. under flowing nitrogen.

Physical characterisation: The particle size was determined by TEM: 50-200 nm; ICP-analysis: 1.44 wt % Ru.

### Comparative Reference Sample 7:

1 wt % Ag on γ-Al₂O₃ (Table 1, Ref7) The sample was prepared by incipient wetness impregnation of Alumina with an aqueous solution of AgNO₃, followed by drying in static air at 80° C. for 24 h and subsequent calcination for 4 hours at 500° C. in static air.

Physical characterisation: The particle size was determined by TEM: 10-30 nm; ICP-analysis: 1.03 wt % Ag.

### Comparative Reference Sample 8:

1 wt % Cu on γ-Al₂O₃ (Table 1, Ref8)

The sample was prepared by incipient wetness impregnation of Alumina with an aqueous solution of Cu(NO₃)₂, followed by drying in static air at 80° C. for 24 h and subsequent calcination for 4 hours at 500° C. in static air.

Physical characterisation: The particle size was determined by TEM: <1 nm; ICP-analysis: 1.02 wt % Cu.

### Comparative Reference Sample 9:

1 wt % Cu on CYZ (Table 1, Ref9)

The sample was prepared by incipient wetness impregnation of CYZ with an aqueous solution of Cu(NO₃)₂, followed by drying in static air at 80° C. for 24 h and subsequent calcination for 4 hours at 500° C. in static air.

Physical characterisation: The particle size was determined by TEM: 1-2 nm; ICP-analysis: 0.92 wt % Cu.

### Comparative Reference Sample 10:

1 wt % Fe on CYZ (Table 1, Ref10)

The sample was prepared by incipient wetness impregnation of CYZ with an aqueous solution of Fe(NO₃)₃, followed by drying in static air at 80° C. for 24 h and subsequent calcination for 4 hours at 500° C. in static air.

Physical characterisation: The particle size was determined by TEM: <1 nm; ICP-analysis: 0.90 wt % Fe.

### Example 1

0.5 wt % Pt on γ-Al₂O₃ (Table 1, 1)

1.03 g of Pt(acac)₂ (48.6% by weight Pt) was coarsely mixed with 103 g of γ-Al₂O₃ in a sealable plastic bottle of 250 mL capacity. Next 10 g Y-stabilised ZrO₂ beads, (5 mm diameter), were added. The bottle was sealed and locked into a rotation mixer (Olbrich Model RM 500, 0.55 KW) and homogenised by vibration for 5 minutes. The bottle was then unlocked from the rotation mixer and the mixture passed through a coarse sieve to remove the beads. Finally the mixed powders were transferred to a calcination vessel and heated under flowing N₂ to 450° C. and kept for a period of 2 hours.

Physical characterisation: The particle size was determined by TEM: <1.5 nm; ICP-analysis: 0.50 wt % Pt.

### Example 2

2.0 wt % Pt on γ-Al₂O₃ (Table 1, 2)

4.11 g of Pt(acac)₂ (48.6% by weight Pt) was coarsely mixed with 102 g of γ-Al₂O₃, followed by the process as described in Example 1. Finally the mixed powders were transferred to a calcination vessel and heated under flowing N₂ to 450° C. and kept for a period of 2 hours.

Physical characterisation: The particle size was determined by TEM: 1-2 nm; ICP-analysis: 2.01 wt % Pt.

### Example 5

0.5 wt % Pd on γ-Al₂O₃ (Table 1, 5)

1.43 g of Pd(acac)₂ (35.0% by weight Pd) was coarsely mixed with 109 g of γ-Al₂O₃, followed by the process as described in Example 1. Finally the mixed powders were transferred to a calcination vessel and heated in static air to 300° C. and kept for a period of 2 hours.

Physical characterisation: The particle size was determined by TEM: 1.5-4 nm; ICP-analysis: 0.45 wt % Pd.

### Example 6

2.0 wt % Pd on CYZ (Table 1, 6)

5.71 g of Pd(acac)₂ (35.0% by weight Pd) was coarsely mixed with 102 g of CYZ, followed by the process as described in Example 1. Finally the mixed powders were transferred to a calcination vessel and heated in static air to 300° C. and kept for a period of 2 hours.

Physical characterisation: The particle size was determined by TEM: <3 nm; ICP-analysis: 1.96 wt % Pd.

### Example 7

2.0 wt % Pd on γ-Al₂O₃ (Table 1, 7)

4.26 g of Pd(OAc)₂ (47.0% by weight Pd) was coarsely mixed with 102 g of γ-Al₂O₃, followed by the process as described in Example 1. Finally the mixed powders were transferred to a calcination vessel and heated in static air to 350° C. and kept for a period of 2 hours.

Physical characterisation: The particle size was determined by TEM: 1-4 nm; ICP-analysis: 1.86 wt % Pd.

### Example 8

2.0 wt % Pd on CYZ (Table 1, 8)

4.26 g of Pd(OAc)₂ (47.0% by weight Pd) was coarsely mixed with 101 g of CYZ, followed by the process as described in Example 1. Finally the mixed powders were transferred to a calcination vessel and heated in static air to 300° C. and kept for a period of 2 hours.

Physical characterisation: The particle size was determined by TEM: <2 nm; ICP-analysis: 2.00 wt % Pd.

### Example 9

2.0 wt % Pd on γ-Al₂O₃ (Table 1, 9)

5.71 g of Pd(acac)₂ (35.0% by weight Pd) was coarsely mixed with 108 g of γ-Al₂O₃, followed by the process as described in Example 1. Finally the mixed powders were transferred to a calcination vessel and heated in static air to 300° C. and kept for a period of 2 hours.

Physical characterisation: The particle size was determined by TEM: 2-5 nm; ICP-analysis: 1.87 wt % Pd.

### Example 10

0.5 wt % Rh on γ-Al₂O₃ (Table 1, 10)

2.06 g of Rh(acac)₃ (24.2% by weight Rh) was coarsely mixed with 109 g of γ-Al₂O₃, followed by the process as described in Example 1. Finally the mixed powders were transferred to a calcination vessel and heated in static air to 300° C. and kept for a period of 2 hours.

Physical characterisation: The particle size was determined by TEM: 2-4 nm; ICP-analysis: 0.52 wt % Rh.

### Example 11

0.5 wt % Rh on γ-Al₂O₃ (Table 1, 11)

2.06 g of Rh(acac)₃ (24.2% by weight Rh) was coarsely mixed with 109 g of γ-Al₂O₃, followed by the process as described in Example 1. Finally the mixed powders were transferred to a calcination vessel and heated under flowing nitrogen to 450° C. and kept for a period of 2 hours.

Physical characterisation: The particle size was determined by TEM: <1.5 nm; ICP-analysis: 0.53 wt % Rh.

### Example 12

0.5 wt % Rh on γ-Al₂O₃ (Table 1, 12)

1.25 g of Rh(CO)₂(acac) (40.0% by weight Rh) was coarsely mixed with 103 g of γ-Al₂O₃, followed by the process as described in Example 1. Finally the mixed powders were transferred to a calcination vessel and heated under flowing nitrogen to 450° C. and kept for a period of 2 hours.

Physical characterisation: The particle size was determined by TEM: <2 nm; ICP-analysis: 0.46 wt % Rh.

### Example 13

2.0 wt % Rh on γ-Al₂O₃ (Table 1, 13)

8.25 g of Rh(acac)₃ (24.2% by weight Rh) was coarsely mixed with 108 g of γ-Al₂O₃, followed by the process as described in Example 1. Finally the mixed powders were transferred to a calcination vessel and heated under flowing nitrogen to 450° C. and kept for a period of 2 hours.

Physical characterisation: The particle size was determined by TEM: 2-4 nm; ICP-analysis: 1.87 wt % Rh.

### Example 14

2.0 wt % Rh on γ-Al₂O₃ (Table 1, 14)

5.00 g of Rh(CO)₂(acac) (40.0% by weight Rh) was coarsely mixed with 102 g of γ-Al₂O₃, followed by the process as described in Example 1. Finally the mixed powders were transferred to a calcination vessel and heated under flowing nitrogen to 450° C. and kept for a period of 2 hours.

Physical characterisation: The particle size was determined by TEM: <4 nm; ICP-analysis: 2.00 wt % Rh.

### Example 15

2.0 wt % Rh on CYZ (Table 1, 15)

8.25 g of Rh(acac)₃ (24.2% by weight Rh) was coarsely mixed with 102 g of CYZ, followed by the process as described in Example 1. Finally the mixed powders were transferred to a calcination vessel and heated in static air to 500° C. and kept for a period of 2 hours.

Physical characterisation: The particle size was determined by TEM: <3 nm; ICP-analysis: 1.99 wt % Rh.

### Example 16

2.0 wt % Ru on γ-Al₂O₃ (Table 1, 16)

7.87 g of Ru(acac)₃ (25.4% by weight Ru) was coarsely mixed with 101 g of γ-Al₂O₃, followed by the process as described in Example 1. Finally the mixed powders were transferred to a calcination vessel and heated under flowing nitrogen to 400° C. and kept for a period of 2 hours.

Physical characterisation: The particle size was determined by TEM: 1-2 nm; ICP-analysis: 1.86 wt % Ru.

### Example 17

2.0 wt % Ru on γ-Al₂O₃ (Table 1, 17)

4.19 g of Ru₃(CO)₁₂ (47.7% by weight Ru) was coarsely mixed with 101 g of γ-Al₂O₃, followed by the process as described in Example 1. Finally the mixed powders were transferred to a calcination vessel and heated under flowing nitrogen to 400° C. and kept for a period of 2 hours.

Physical characterisation: The particle size was determined by TEM: 1-2 nm; ICP-analysis: 1.92 wt % Ru.

### Example 18

PdRh on γ-Al₂O₃ with 1 wt % Pd and 1 wt % Rh (Table 1, 18)

4.12 g of Rh(acac)₃, 2.86 g of Pd(acac)₂ were coarsely mixed with 103 g of γ-Al₂O₃, followed by the process as described in Example 1. Finally the mixed powders were transferred to a calcination vessel and heated in static air to 500° C. and kept for a period of 2 hours.

Physical characterisation: The particle size was determined by TEM: 2-6 nm; ICP-analysis: 0.93 wt % Pd and 1.04 wt % Rh.

### Example 19

PtPd on γ-Al₂O₃ with 1 wt % Pt and 1 wt % Pd (Table 1, 19) 2.06 g of Pt(acac)₂, 2.86 g of Pd(acac)₂ were coarsely mixed with 103 g of γ-Al₂O₃, followed by the process as described in Example 1. Finally the mixed powders were transferred to a calcination vessel and heated under flowing nitrogen to 500° C. and kept for a period of 2 hours.

Physical characterisation: The particle size was determined by TEM: 2-3 nm; ICP-analysis: 1.07 wt % Pt and 0.96 wt % Pd.

### Example 20

PtFe on γ-Al₂O₃ with 1 wt % Pt and 1 wt % Fe (Table 1, 20)

2.06 g of Pt(acac)₂, 6.33 g of Fe(acac)₃ were coarsely mixed with 103 g of γ-Al₂O₃, followed by the process as described in Example 1. Finally the mixed powders were transferred to a calcination vessel and heated under flowing nitrogen to 500° C. and kept for a period of 2 hours.

Physical characterisation: The particle size was determined by TEM: 1-3 nm; ICP-analysis: 0.97 wt % Pt and 1.02 wt % Fe.

### Example 21

RhFe on γ-Al₂O₃ with 1 wt % Rh and 1 wt % Fe (Table 1, 21)

4.12 g of Rh(acac)₃, 6.33 g of Fe(acac)₃ were coarsely mixed with 103 g of γ-Al₂O₃, followed by the process as described in Example 1. Finally the mixed powders were transferred to a calcination vessel and heated under flowing nitrogen to 500° C. and kept for a period of 2 hours.

Physical characterisation: The particle size was determined by TEM: 3-5 nm; ICP-analysis: 0.88 wt % Rh and 1.02 wt % Fe.

### Example 22

PdRh on γ-Al₂O₃ with 1 wt % Pd and 1 wt % Rh (Table 1, 18)

4.12 g of Rh(acac)₃, 2.86 g of Pd(acac)₂ were coarsely mixed with 103 g of γ-Al₂O₃, followed by the process as described in Example 1. Finally the mixed powders were transferred to a calcination vessel and heated under flowing nitrogen to 500° C. and kept for a period of 2 hours.

Physical characterisation: The particle size was determined by TEM: 2-5 nm; ICP-analysis: 1.11 wt % Rh and 0.96 wt % Pd.

### Example 23

1.0 wt % Ag on γ-Al₂O₃ (Table 1, 23)

1.92 g of Ag(acac) (52.1% by weight Ag) was coarsely mixed with 104 g of γ-Al₂O₃, followed by the process as described in Example 1. Finally the mixed powders were transferred to a calcination vessel and heated in static air to 500° C. and kept for a period of 1 hour.

Physical characterisation: The particle size was determined by TEM: 5-10 nm; ICP-analysis: 0.87 wt % Ag.

### Example 24

1.0 wt % Cu on γ-Al₂O₃ (Table 1, 24)

4.12 g of Cu(acac)₂ (24.2% by weight Cu) was coarsely mixed with 104 g of γ-Al₂O₃, followed by the process as described in Example 1. Finally the mixed powders were transferred to a calcination vessel and heated under flowing nitrogen to 500° C. and kept for a period of 1 hour.

Physical characterisation: The particle size was determined by TEM: <1 nm; ICP-analysis: 0.97 wt % Cu.

### Example 25

1.0 wt % Cu on CYZ (Table 1, 25)

4.12 g of Cu(acac)₂ (24.2% by weight Cu) was coarsely mixed with 103 g of CYZ, followed by the process as described in Example 1. Finally the mixed powders were transferred to a calcination vessel and heated in static air to 400° C. and kept for a period of 1 hour.

Physical characterisation: The particle size was determined by TEM: <1 nm; ICP-analysis: 0.87 wt % Cu.

### Example 26

1.0 wt % Fe on CYZ (Table 1, 26)

6.33 g of Fe(acac)₃ (15.8% by weight Fe) was coarsely mixed with 103 g of CYZ, followed by the process as described in Example 1. Finally the mixed powders were transferred to a calcination vessel and heated in static air to 400° C. and kept for a period of 1 hour.

Physical characterisation: The particle size was determined by TEM: <1 nm; ICP-analysis: 0.87 wt % Fe.

### Comparative Reference Sample 11:

2 wt % Pd on La/Al₂O₃ (Table 2, Ref11)

The sample was prepared by incipient wetness impregnation of La/Al₂O₃ with an aqueous solution of Pd(NO₃)₂, followed by drying in static air at 80° C. for 24 h and subsequent calcination for 4 hours at 550° C. in static air.

Physical characterisation: The Pd dispersion was determined by CO chemisorption: 25.9%; ICP-analysis: 1.97 wt % Pd.

### Comparative Reference Sample 12:

4 wt % Pd on La/Al₂O₃ (Table 2, Ref12)

The sample was prepared by incipient wetness impregnation of La/Al₂O₃ with an aqueous solution of Pd(NO₃)₂, followed by drying in static air at 80° C. for 24 h and subsequent calcination for 4 hours at 550° C. in static air.

Physical characterisation: The Pd dispersion was determined by CO chemisorption: 19.7%; ICP-analysis: 3.86 wt % Pd.

### Comparative Reference Sample 13:

6 wt % Pd on La/Al₂O₃ (Table 2, Ref13)

The sample was prepared by incipient wetness impregnation of La/Al₂O₃ with an aqueous solution of Pd(NO₃)₂, followed by drying in static air at 80° C. for 24 h and subsequent calcination for 4 hours at 550° C. in static air.

Physical characterisation: The Pd dispersion was determined by CO chemisorption: 16.6%; ICP-analysis: 5.71 wt % Pd.

### Comparative Reference Sample 14:

8 wt % Pd on La/Al₂O₃ (Table 2, Ref14)

The sample was prepared by incipient wetness impregnation of La/Al₂O₃ with an aqueous solution of Pd(NO₃)₂, followed by drying in static air at 80° C. for 24 h and subsequent calcination for 4 hours at 550° C. in static air.

Physical characterisation: The Pd dispersion was determined by CO chemisorption: 15.8%; ICP-analysis: 7.62 wt % Pd.

### Example 27

2.0 wt % Pd on La/Al₂O₃ (Table 2, 27)

4.26 g of Pd(OAc)₂ (47.0% by weight Pd) was coarsely mixed with 102 g of La/Al₂O₃, followed by the process as described in Example 1. Finally the mixed powders were transferred to a calcination vessel and heated in static air to 450° C. and kept for a period of 2 hours.

Physical characterisation: The Pd dispersion was determined by CO chemisorption: 25.8%; ICP-analysis: 1.85 wt % Pd.

### Example 28

4.0 wt % Pd on La/Al₂O₃ (Table 2, 28)

8.51 g of Pd(OAc)₂ (47.0% by weight Pd) was coarsely mixed with 100 g of La/Al₂O₃, followed by the process as described in Example 1. Finally the mixed powders were transferred to a calcination vessel and heated in static air to 450° C. and kept for a period of 2 hours.

Physical characterisation: The Pd dispersion was determined by CO chemisorption: 33.7%; ICP-analysis: 3.86 wt % Pd.

### Example 29

6.0 wt % Pd on La/Al₂O₃ (Table 2, 29)

12.77 g of Pd(OAc)₂ (47.0% by weight Pd) was coarsely mixed with 97 g of La/Al₂O₃, followed by the process as described in Example 1. Finally the mixed powders were transferred to a calcination vessel and heated in static air to 450° C. and kept for a period of 2 hours.

Physical characterisation: The Pd dispersion was determined by CO chemisorption: 31.2%; ICP-analysis: 5.61 wt % Pd.

### Example 30

8.0 wt % Pd on La/Al₂O₃ (Table 2, 30)

17.02 g of Pd(OAc)₂ (47.0% by weight Pd) was coarsely mixed with 95 g of La/Al₂O₃, followed by the process as described in Example 1. Finally the mixed powders were transferred to a calcination vessel and heated in static air to 450° C. and kept for a period of 2 hours.

Physical characterisation: The Pd dispersion was determined by CO chemisorption: 27.0%; ICP-analysis: 7.50 wt % Pd.

### Example 31

2.0 wt % Pd on La/Al₂O₃ (Table 2, 31)

5.71 g of Pd(acac)₂ (35.0% by weight Pd) was coarsely mixed with 102 g of La/Al₂O₃, followed by the process as described in Example 1. Finally the mixed powders were transferred to a calcination vessel and heated in static air to 350° C. and kept for a period of 2 hours.

Physical characterisation: The Pd dispersion was determined by CO chemisorption: 40.0%; ICP-analysis: 1.98 wt % Pd.

### Example 32

4.0 wt % Pd on La/Al₂O₃ (Table 2, 32)

11.43 g of Pd(acac)₂ (35.0% by weight Pd) was coarsely mixed with 99.7 g of La/Al₂O₃, followed by the process as described in Example 1. Finally the mixed powders were transferred to a calcination vessel and heated in static air to 350° C. and kept for a period of 2 hours.

Physical characterisation: The Pd dispersion was determined by CO chemisorption: 27.2%; ICP-analysis: 3.79 wt % Pd.

### Example 33

6.0 wt % Pd on La/Al₂O₃ (Table 2, 33)

17.14 g of Pd(acac)₂ (35.0% by weight Pd) was coarsely mixed with 98.0 g of La/Al₂O₃, followed by the process as described in Example 1. Finally the mixed powders were transferred to a calcination vessel and heated in static air to 350° C. and kept for a period of 2 hours.

Physical characterisation: The Pd dispersion was determined by CO chemisorption: 24.2%; ICP-analysis: 5.83 wt % Pd.

### Example 34

8.0 wt % Pd on La/Al₂O₃ (Table 2, 34)

22.86 g of Pd(acac)₂ (35.0% by weight Pd) was coarsely mixed with 95.6 g of La/Al₂O₃, followed by the process as described in Example 1. Finally the mixed powders were transferred to a calcination vessel and heated in static air to 350° C. and kept for a period of 2 hours.

Physical characterisation: The Pd dispersion was determined by CO chemisorption: 17.1%; ICP-analysis: 7.54 wt % Pd.

### Example 35

2.0 wt % Pd on La/Al₂O₃ (Table 2, 35)

8.89 g of Pd(tmhd)₂ (22.5% by weight Pd) was coarsely mixed with 101.8 g of La/Al₂O₃, followed by the process as described in Example 1. Finally the mixed powders were transferred to a calcination vessel and heated in static air to 350° C. and kept for a period of 2 hours.

Physical characterisation: The Pd dispersion was determined by CO chemisorption: 47.3%; ICP-analysis: 1.97 wt % Pd.

### Example 36

4.0 wt % Pd on La/Al₂O₃ (Table 2, 36)

17.78 g of Pd(tmhd)₂ (22.5% by weight Pd) was coarsely mixed with 99.7 g of La/Al₂O₃, followed by the process as described in Example 1. Finally the mixed powders were transferred to a calcination vessel and heated in static air to 350° C. and kept for a period of 2 hours.

Physical characterisation: The Pd dispersion was determined by CO chemisorption: 34%; ICP-analysis: 4.03 wt % Pd.

### Example 37

6.0 wt % Pd on La/Al₂O₃ (Table 2, 37)

26.67 g of Pd(tmhd)₂ (22.5% by weight Pd) was coarsely mixed with 97.6 g of La/Al₂O₃, followed by the process as described in Example 1. Finally the mixed powders were transferred to a calcination vessel and heated in static air to 350° C. and kept for a period of 2 hours.

Physical characterisation: The Pd dispersion was determined by CO chemisorption: 15.9%; ICP-analysis: 5.76 wt % Pd.

### Example 38

8.0 wt % Pd on La/Al₂O₃ (Table 2, 38)

35.56 g of Pd(tmhd)₂ (22.5% by weight Pd) was coarsely mixed with 95.6 g of La/Al₂O₃, followed by the process as described in Example 1. Finally the mixed powders were transferred to a calcination vessel and heated in static air to 350° C. and kept for a period of 2 hours.

Physical characterisation: The Pd dispersion was determined by CO chemisorption: 14%; ICP-analysis: 7.80 wt % Pd.

### Application Example 1

The resultant powders in Examples were meshed as listed in Table 3 and tested without further modification. The measurements were performed using a conventional plug flow model gas reactor. In these measurements gas streams, simulating lean burn exhaust gas, were passed over and through meshed particles of test samples under conditions of varying temperature and the effectiveness of the sample in CO oxidation was determined by means of on-line FTIR (Fourier Transform Infra-Red) spectrometer. Table 3 details the full experimental parameters employed in the generation of the data included herein.

TABLE 3
Model Gas testing conditions

| | |
|---|---|
| Component/parameter | Concentration/Setting |

| | | |
|---|---|---|
| CO | 350 | ppm |
| NO | 150 | ppm |

| | |
|---|---|
| H₂O | 3% |
| O₂ | 6% |
| Temperature | Ramp 85 to 500° C. @ +2° C./min |

| | | |
|---|---|---|
| Sample mass | 70 | mg |
| SiC | 200 | mg |
| Particle size of sample | 500-700 | μm |
| GHSV | 100000 | h⁻¹ |

1. A process for the preparation of highly dispersed transition metal or metals deposited on refractory oxides and mixtures thereof, comprising the steps of:
i) without using a solvent providing a dry intimate mixture of a refractory oxide selected from the group consisting of Aluminas, heteroatom doped transition Aluminas, Silica, Ceria, Zirconia, Ceria-Zirconia based solution, Lanthanum oxide, Magnesia, Titania, Tungsten oxide and mixtures thereof;
with one or more precursor compound or compounds comprising a complex formed out of a transition metal and ligands, the complex decomposing to yield the metal or metal ion at temperatures between 100° C. and 500° C.; and
which has a structure of formula I:
ML¹ₘL²ₙ (I),
wherein:
M is a metal chosen from the group mentioned above.
L¹ is carbonyl, amine, alkene, arene, phosphine or other neutral coordinating ligand;
L² is acetate, alkoxy or advantageously embraces a diketonate, ketoiminato or related member of this homologous series like a ligand of formula II: 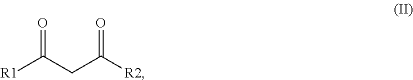
wherein:
R1 and R2 are independently alkyl, substituted alkyl, aryl, substituted aryl, acyl and substituted acyl; and
in formula I, m can be a number ranging from 0 to 6, a may take a number equal to the valence of M and m+n is not less than 1; and
ii) calcining the mixture without reduced pressure and without the presence of specific reaction gases at a temperature of 200° C.-650° C. and a time sufficient to decompose the metal precursor; and—
iii) obtaining the supported oxide.

2. A process according to claim 1, wherein the metal is selected from the group of Pd, Pt, Rh, Ir, Ru, Ag, Au, Cu, Fe, Mn, Mo, Ni, Co, Cr, V, W, Nb, Y, La (lanthanides) or mixtures thereof.

3. A process according to claim 1, wherein the complex ligand is selected from one or a mixture of the group comprising a diketonate-structure, carbonyl species, acetates, and alkenes.

4. A process according to claim 1, wherein the mixture is calcined at a temperature of 250-450° C. for 10 mins-4 hours.

5. A process according to claim 1, wherein the mixture comprises the refractory oxide and the precursor compound to provide a subsequent metal loading on the oxide of 0.01 wt % metal to 20 wt % metal.

6. A material or mixture of materials obtained according to claim 1.

7. A catalyst comprising the material or mixture of materials according to claim 6.

8. A catalyst according to claim 7, wherein the material or mixture of materials and optionally further materials are coated in zones on a substrate.

9. A monolith catalyst formed via extrusion of the material or mixture of materials of claim 8.

10. A process for the abatement of exhaust pollutants comprising subjecting an exhaust with exhaust pollutants to the material or mixture of materials of claim 6.
